(19) United States
(12) Patent Application Publication
(10) Pub. No.: US 2022/0275142 A1
(43) Pub. Date: Sep. 1, 2022

(54) TRANSITION METAL CHELATING POLYOL BLEND FOR USE IN A POLYURETHANE POLYMER

(71) Applicant: Dow Global Technologies LLC, Midland, MI (US)

(72) Inventors: Dakai Ren, Manvel, TX (US); William J. Harris, Lake Jackson, TX (US); Brad C. Bailey, Midland, MI (US)

(73) Assignee: Dow Global Technologies LLC, Midland, MI (US)

(21) Appl. No.: 17/626,253

(22) PCT Filed: Jul. 8, 2020
(86) PCT No.: PCT/US2020/041184

§ 371 Date: Jan. 11, 2022

Related U.S. Application Data
(60) Provisional application No. 62/873,362, filed on Jul. 12, 2019.

(51) Int. Cl. C08G 18/42; C08G 18/76; C08G 18/18; C08J 9/14

(52) U.S. Cl. CPC C08G 18/4213; C08G 18/7664; C08G 18/1808; C08J 9/141; C08J 9/0042

(57) ABSTRACT

The present disclosure provides for a liquid transition metal chelating polyol blend that can be used in an isocyanate-reactive composition and a reaction mixture for forming a polyurethane polymer. The liquid transition metal chelating polyol blend includes a polyol, a transition metal compound having a transition metal ion and a chelating agent having a nitrogen based chelating moiety, where the liquid transition metal chelating polyol blend has a molar ratio of nitrogen in the nitrogen based chelating moiety to the transition metal ion of 8:1 to 1:1 (moles nitrogen:moles of transition metal ion).

### FIELD OF DISCLOSURE

The present disclosure relates generally to a polyurethane polymer and more particularly to a polyurethane polymer with improved combustion/smoke behavior.

### BACKGROUND

Polyurethane rigid (PUR) foam has been used in construction since the 1960s as a high-performance insulation material. Continued technical developments in Europe and the US have led to the next product generation called polyisocyanurate rigid (PIR) foam. Both PUR and PIR are polyurethane polymer foams manufactured from the two reactants, isocyanate (e.g., methyl diphenyl diisocyanate, MDI) and polyol. While for PUR, the isocyanate and polyol are implemented near a balanced ratio compared to the equivalent weights, the isocyanate is used in excess during the production of PIR. The isocyanate reacts in part with itself, where the resulting PIR is a heavily cross-linked synthetic material with ring-like isocyanurate structures. The high degree of linkage and the ring structures ensure the high thermal stability of the rigid PIR foam. PIR also has superior thermal stability and dimensional stability.

PIR foams are also characterized by a very good fire resistance behavior thanks to the inherent charring behavior, in turn related to the outstanding thermal stability of the isocyanurate chemical structure. To further enhance char formation, it is common to add a phosphorous-based flame retardant. When a building product, such as an insulating transition metal panel or an insulation board, is exposed to fire, the insulating PIR core rapidly forms a coherent char that helps in protecting underlying material. That translates to only a limited portion of the available combustible insulating material exposed to the fire that actually contributes in terms of heat release and smoke.

Fire behavior of combustible thermoset material is a complex matter. As an example, halogenated flame retardants are very effective in reducing heat release but may worsen smoke opacity. Dow patent publication US 2014/0206786 A1 describes the use of triethyl phosphate (TEP) as a smoke suppressant additive when compared with a conventional halogenated flame retardant such as tris-(2-chloroisopropyl) phosphate (TCPP). Moreover, as is well known, the composition of combustion effluents (further than on the material itself) strongly depends on fire conditions, particularly temperature, geometry and ventilation including availability of oxygen. Even if, as noted above, the intrinsic charring behavior of polyisocyanurate limits and/or delays the amount of polymer burned (therefore limiting and/or delaying the release of heat and smoke), still it is desirable to further modify the combustion/burning behavior and therefore reduce as much as possible smoke opacity and smoke toxicants.

Polyurethanes also are used widely in a large array of coating, adhesive, sealant and elastomer (“CASE”) applications as well as flexible polyurethane foams. It is desirable to further modify the combustion/burning behavior and therefore reduce as much as possible smoke opacity and smoke toxicants as well as optionally modify other attributes such as antifungal, antimicrobial, odor resistance, hardness, sound dampening, and friction resistance of polyurethanes utilized as coatings, adhesives, sealants, elastomers, and flexible foams.

### SUMMARY

The present disclosure provides for a liquid transition metal chelating polyol blend that can be used in an isocyanate-reactive composition and a reaction mixture that includes the isocyanate-reactive composition for forming a polyurethane polymer. The polyurethane polymer and the polyurethane polymer foam of the present disclosure can have improved smoke behavior with respect to emission of hydrogen cyanide (HCN) and carbon monoxide (CO) during a pyrolysis event (e.g., a fire).

The liquid transition metal chelating polyol blend of the present disclosure includes a polyol, a transition metal compound having a transition metal ion and a chelating agent having a nitrogen based chelating moiety, where there is 0.05 weight percent (wt. %) to 10.0 wt. % of the transition metal ion from the transition metal compound, the wt. % based on the total weight of the liquid transition metal chelating polyol blend, and where the liquid transition metal chelating polyol blend has 0.001 to 1.0 moles of nitrogen in the nitrogen based chelating moieties per 100 gram (g) of the polyol in the liquid transition metal chelating polyol blend, and has a molar ratio of nitrogen in the nitrogen based chelating moiety to the transition metal ion of 8.0:1.0 to 1.0:1.0 (moles nitrogen:moles of transition metal ion), where for the various embodiments the molar ratio of nitrogen in the nitrogen based chelating moiety to the transition metal ion is preferably 4.0:1.0 to 1.0:1.0 (moles nitrogen:moles of transition metal ion), more preferably a molar ratio of nitrogen in the nitrogen based chelating moiety to the transition metal ion of 2.8:1.0 to 1.0:1.0 (moles nitrogen:moles of transition metal ion), most preferably a molar ratio of nitrogen in the nitrogen based chelating moiety to the transition metal ion of 2.0:1.0 to 1.0:1.0 (moles nitrogen: moles of transition metal ion). In various embodiments, the chelating agent is soluble in the polyol of the transition metal chelating polyol blend where the liquid transition metal chelating polyol blend has 0.001 to 1.0 moles of nitrogen in the nitrogen based chelating moiety per 100 g of the polyol in the liquid transition metal chelating polyol blend, preferably 0.003 to 0.60 moles of nitrogen in the nitrogen based chelating moiety per 100 g of polyol in the liquid transition metal chelating polyol blend, more preferably 0.006 to 0.40 moles of nitrogen in the nitrogen based chelating moiety per 100 g of polyol in the liquid transition metal chelating polyol blend and most preferably 0.01 to 0.20 moles of nitrogen in the nitrogen based chelating moiety per 100 g of polyol in the liquid transition metal chelating polyol blend.

In various embodiments, the polyol is an aromatic polyester polyol having an aromatic moiety that constitutes 5 weight percent (wt. %) to 60 wt. % of the total weight of the aromatic polyester polyol. In various embodiments, the polyester polyol is preferably an aromatic polyester polyol having an aromatic moiety that constitutes 10 wt. % to 40 wt. % of the total weight of the aromatic polyester polyol. In various embodiments, the polyester polyol is most preferably an aromatic polyester polyol having an aromatic moiety that constitutes 10 wt. % to 20 wt. % of the total weight of the aromatic polyester polyol.

For the embodiments, the transition metal compound is selected from the group consisting of a transition metal carboxylate, a transition metal salt, a transition metal coordinate compound, and combinations thereof. Preferably the transition metal compound is a transition metal carboxylate. The transition metal ion is selected from the group consisting of copper, zinc, silver, iron, manganese, cobalt, nickel, zirconium, cadmium, mercury, palladium, titanium, vanadium and combinations thereof. More preferably, the transition metal ion is selected from the group consisting of copper, zinc, silver, iron, manganese, cobalt, nickel, zirconium and combinations thereof. Most preferably, the transition metal ion is selected from the group consisting of copper, zinc, iron, manganese, cobalt, nickel, and combinations thereof. For the embodiments, the transition metal compound can be selected from the group consisting of copper 2-ethylhexanoate (CuEH), copper (I) acetate, copper acetate, copper (II) acetate mote hydrate (Cu((OAc)₂H₂O), copper (II) propionate, copper (II) isobutyrate (Cu(i-Bu)₂), cobalt (II) acetate, nickel (II) acetate, silver (I) acetate and combinations thereof.

For the embodiments, the chelating agent having a nitrogen based chelating moiety is selected from the group consisting of a diamine chelating moiety, a triamine chelating moiety, a tetraamine chelating moiety, and combinations thereof. Preferably, the chelating agent having a nitrogen based chelating moiety is selected from the group consisting of 2,2′-bipyridine, N,N,N′,N′-tetramethylethylenediamine, N,N,N′,N′,N″-pentamethyldiethylenetriamine, 2-[[2-(dimethylamino)ethyl] methylamino]ethanol, 1-[bis[3-(dimethylamino)propyl]amino-2-propanol], a 1,2-ethanediamine polymer with methyl oxirane and combinations thereof.

The present disclosure also provides for an isocyanate-reactive composition that includes the liquid transition metal chelating polyol blend as provided herein, where the isocyanate-reactive composition can be used in forming a polyurethane polymer. For the various embodiments, the isocyanate-reactive composition can further include a polyol separate from the polyol in the liquid transition metal chelating polyol blend, where the isocyanate-reactive composition includes 0.1 to 100 weight percent (wt. %) of the liquid transition metal chelating polyol blend and up to 99.9% of the polyol separate from the polyol of the liquid transition metal chelating polyol blend to form the isocyanate-reactive composition for a polyurethane polymer, the wt. % based on the total weight of the isocyanate-reactive composition. In an additional embodiment, the isocyanate-reactive composition of the present disclosure can optionally include a polyol (separate from the polyol in the liquid transition metal chelating polyol blend), a phosphorus flame retardant, a catalyst, a blowing agent, water, a surfactant or a combination thereof, where the isocyanate-reactive composition can be used in forming a polyurethane polymer foam. For example, the isocyanate-reactive composition as provided herein can include a blowing agent and a surfactant for use in forming a polyurethane polymer foam.

For the various embodiments, the isocyanate-reactive composition of the present disclosure can further include 0.1 wt. % to 7.0 wt. % of phosphorus from a flame-retardant compound, preferably from a halogen-free flame-retardant compound, selected from the group consisting of a phosphate, a phosphonate, a phosphinate, a phosphite and combinations thereof, the wt. % of phosphorus based on the overall weight of the isocyanate-reactive composition. For the various embodiments, the isocyanate-reactive composition of the present disclosure includes 0.05 wt. % to 10.0 wt. % of the transition metal ion from the liquid transition metal chelating polyol blend, where the wt. % of the transition metal ion is based on the total weight of the liquid transition metal chelating polyol blend. For such embodiments, the isocyanate-reactive composition can have a molar ratio of the transition metal ion to phosphorus (mole transition metal ion:mole phosphorous) of 0.05:1 to 5:1.

Embodiments of the present disclosure also provide for a reaction mixture for forming a polyurethane polymer, where the reaction mixture includes an isocyanate compound having an isocyanate moiety and the isocyanate-reactive composition as provided herein, where the polyol includes a hydroxyl moiety, and the reaction mixture has a molar ratio of the isocyanate moiety to the hydroxyl moiety of 0.90:1 to 7:1. In an additional embodiment, the reaction mixture can be used in forming a polyurethane polymer foam, where the reaction mixture includes an isocyanate compound having an isocyanate moiety and the isocyanate-reactive composition as provided herein, where the polyol includes a hydroxyl moiety, and the reaction mixture has a molar ratio of the isocyanate moiety to the hydroxyl moiety of 0.90:1 to 7:1. In additional embodiments, the reaction mixture can further include compounds selected from the group consisting of water, a catalyst, a surfactant, a blowing agent or combinations thereof.

The present disclosure provides for a process for preparing a liquid transition metal chelating polyol blend, where the process includes providing a polyol; providing a chelating agent having a nitrogen based chelating moiety and providing a transition metal compound having a transition metal ion. The process further includes admixing the polyol, the chelating agent and the transition metal compound to form the liquid transition metal chelating polyol blend having 0.001 to 1.0 moles of nitrogen in the nitrogen based chelating moieties per 100 g of the polyol in the liquid transition metal chelating polyol blend. For the various embodiments, the liquid transition metal chelating polyol blend has a molar ratio of nitrogen in the nitrogen based chelating moiety to the transition metal ion of 8.0:1.0 to 1.0:1.0 (moles nitrogen:moles of transition metal ion).

The present disclosure also provides for a process for preparing a reaction mixture for producing a polyurethane polymer, where the process includes providing an isocyanate-reactive composition as provided herein; providing an isocyanate compound having an isocyanate moiety; and admixing the isocyanate-reactive composition and the isocyanate compound to form the reaction mixture having a molar ratio of the isocyanate moiety to the hydroxyl moiety of 0.90:1 to 7:1. For the various embodiments, admixing the isocyanate-reactive composition and the isocyanate compound can further include admixing water, a catalyst, a surfactant, a flame retardant, a blowing agent, an additive or combinations thereof with the reaction mixture to form a polyurethane polymer, including a polyurethane foam.

### DETAILED DESCRIPTION

The present disclosure provides for a liquid transition metal chelating polyol blend that can be used in an isocyanate-reactive composition and a reaction mixture that includes the isocyanate-reactive composition for forming a polyurethane polymer. The polyurethane polymer and the polyurethane foam of the present disclosure can have improved smoke behavior with respect to emission of hydrogen cyanide (HCN) and carbon monoxide (CO) during a pyrolysis event (e.g., a fire).

The liquid transition metal chelating polyol blend of the present disclosure includes a polyol, a transition metal compound having a transition metal ion and a chelating agent having a nitrogen based chelating moiety, where there is 0.05 weight percent (wt. %) to 10.0 wt. % of the transition metal ion from the transition metal compound, the wt. % based on the total weight of the liquid transition metal chelating polyol blend, and where the liquid transition metal chelating polyol blend has 0.001 to 1.0 moles of nitrogen in the nitrogen based chelating moiety per 100 grams (g) of polyol in the liquid transition metal chelating polyol blend. In various embodiments, the liquid transition metal chelating polyol blend has a molar ratio of nitrogen in the nitrogen based chelating moiety to the transition metal ion of 8.0:1.0 to 1.0:1.0 (moles nitrogen:moles of transition metal ion), where for the various embodiments the molar ratio of nitrogen in the nitrogen based chelating moiety to the transition metal ion is preferably 4.0:1.0 to 1.0:1.0 (moles nitrogen:moles of transition metal ion), more preferably a molar ratio of nitrogen in the nitrogen based chelating moiety to the transition metal ion of 2.8:1.0 to 1.0:1.0 (moles nitrogen:moles of transition metal ion), most preferably a molar ratio of nitrogen in the nitrogen based chelating moiety to the transition metal ion of 2.0:1.0 to 1.0:1.0 (moles nitrogen:moles of transition metal ion). As used herein, a liquid transition metal chelating polyol blend is in a liquid state at a pressure of 80 to 25,000 KPa and is in a liquid state at a temperature above −10° C. and lower than 80° C., preferably lower than 60° C., more preferably lower than 40° C., most preferably lower than 25° C. As used herein, the liquid transition metal chelating polyol blend contains no-to-nominal amounts of transition metal compound particles/solids such that a nominal amount of transition metal compound particles/solids is less than 0.10 weight percent (wt. %), preferably less than 0.01 wt. %, more preferably less than 0.001 wt. % based on the weight of liquid transition metal chelating polyol blend.

In various embodiments, the polyol in the transition metal chelating polyol blend is selected from the group consisting of a polyester polyol, polyether polyol, polycarbonate polyol, a polyethercarbonate polyol and combinations thereof. In some embodiments, the polyol is preferably a polyester polyol. In other embodiments, the polyol is preferably a polyether polyol.

The polyester polyol of the present disclosure may be a homopolymer, a random copolymer, a block copolymer, a segmented copolymer as well as a capped product that may contain residues of the initiator in the case of a ring-opened polyester polyol. The polyester polyol can be aromatic, aliphatic or cycloaliphatic and can include their hydrogenated products. In various embodiments, the polyester polyol is an aromatic polyester polyol having an aromatic moiety that constitutes 5 weight percent (wt. %) to 60 wt. % of the total weight of the aromatic polyester polyol. In various embodiments, the polyester polyol is preferably an aromatic polyester polyol having an aromatic moiety that constitutes 10 wt. % to 40 wt. % of the total weight of the aromatic polyester polyol. In various embodiments, the polyester polyol is more preferably an aromatic polyester polyol having an aromatic moiety that constitutes 10 wt. % to 20 wt. % of the total weight of the aromatic polyester polyol. As used herein, an “aromatic moiety” is at least one cyclically conjugated molecular moiety in the form of a planar unsaturated ring of carbon atoms that is covalently attached to the isocyanate reactive compound. The planar unsaturated ring of carbon atoms can have at least six (6) carbon atoms. To illustrate, the isocyanate reactive compound bis(2-hydroxyethyl) terephthalate with a molecular formula of C₁₂H₁₄O₆ and formula weight of 254.2 gram/mole and would have an aromatic content corresponding to a molecular formula of C₆H₄ with corresponding formula weight of 76.1 gram/mole with the aromatic moiety of bis(2-hydroxyethyl) terephthalate being 29.9 weight percent (wt. %).

The liquid polyester polyol can have a low to moderate number average molecular weight ranging from 100 to 5,000, preferably 200 to 2,500, more preferably from 300 to 1,000 and most preferably from 350 to 750. The number average molecular weight can be measured using end group analysis or gel permeation chromatography (GPC), as is known in the art. The liquid polyester polyol can also have a number averaged isocyanate reactive group functionality (e.g., hydroxyl groups) per molecule of 1.8 to 4, such as 2 to 3, where each value is an average number. A variety of chemical structures may make up the liquid polyester polyol with at least one requirement being the presence of at least two hydroxyl groups (i.e., a diol) and that the liquid polyester polyol be in a liquid state at a pressure of 80 to 25,000 KPa and is in liquid state at a temperature above −10° C. and lower than 80° C.,

For the embodiments, monomers used in forming the liquid polyester polyol can include a polyhydric alcohol, such as dihydric alcohols, trihydric alcohols, and/or higher hydric alcohols, and a polybasic acid, such as a dibasic acid and/or tribasic acid such as a carboxylic acid and/or polycarboxylic acid anhydrides or corresponding polycarboxylic acid esters of lower alcohols, a cyclic ester or mixtures thereof, where these compounds are reacted as is known in the art to form a reaction product of the liquid polyester polyol. Exemplary polyhydric alcohols include, but are not limited to, ethylene glycol, propylene glycol-(1,2) and -(1,3), butylene glycol-(1,4) and -(2,3), hexanediol-(1,6), octanediol-(1,8), neopentyl glycol, cyclohexanedimethanol (1,4-bis-hydroxy-methylcyclohexane and other isomers), 2-methyl-1,3-propane-diol, glycerol, trimethylolpropane, hexanetriol-(1,2,6), butanetriol-(1,2,4), trimethylolethane, pentaerythritol, quinitol, mannitol and sorbitol, methyl glycoside, diethylene glycol, triethylene glycol, tetraethylene glycol, polyethylene glycols, dipropylene glycol, polypropylene glycols, dibutylene glycol and polybutylene glycols. The polyhydric alcohols can also include polycarbonate polyols, such as the reaction product of diols, such as propanediol-(1,3), butanediol-(1,4) and/or hexanediol-(1,6), diethylene glycol, triethylene glycol or tetraethylene glycol, with diarylcarbonates, such as diphenylcarbonate, dialiphaticcarbonates, such as dimethylcarbonate or phosgene or from the reaction of oxiranes and carbon dioxide.

The polybasic acids may be aliphatic, cycloaliphatic, aromatic and/or heterocyclic and they may be substituted, e.g. by halogen atoms, and/or may be unsaturated. Suitable polybasic acids, anhydrides, and polycarboxylic acid esters of lower alcohols include, but are not limited to, succinic acid, adipic acid, suberic acid, azelaic acid, sebacic acid, phthalic acid, isophthalic acid, terephthalic acid, trimellitic acid, phthalic acid anhydride, trimellitic anhydride, tetrahydrophthalic acid anhydride, hexahydrophthalic acid anhydride, tetrachlorophthalic acid anhydride, endomethylene tetrahydrophthalic acid anhydride, glutaric acid anhydride, maleic acid, maleic acid anhydride, fumaric acid, dimeric and trimeric fatty acids, such as oleic acid, optionally mixed with monomeric fatty acids, dimethyl terephthalate and terephthalic acid-bis-glycol esters.

The cyclic ester may be aliphatic and may be substituted, e.g. by alkyl groups, and/or may be unsaturated. Suitable cyclic esters include but are not limited to ε-caprolactone, d,l-lactide, glycolide, δ-valerolactone and pivolactone, among others.

The liquid polyester polyol can be aromatic, aliphatic or cycloaliphatic and can include their hydrogenated products. Preferred examples of liquid polyester polyols include, but are not limited to, polycaprolactone polyol, polypropiolactone polyol, polyglycolide polyol, polypivolylactone polyol, polyvalerolactone polyol, polyethylene adipate polyol, polypropylene adipate polyol, polybutylene adipate polyol, polyhexamethylene adipate polyol, polyneopentyl adipate polyol, polycyclohexanedimethylene adipate polyol, polyethylene succinate polyol, polypropylene succinate polyol, polybutylene succinate polyol, polyhexamethylene succinate polyol, polyneopentyl succinate polyol, polycyclohexanedimethyl succinate polyol, polyethylene azelate polyol, polypropylene azelate polyol, polybutylene azelate polyol, polyhexamethylene azelate polyol, polyneopentyl azelate polyol, polycyclohexanedimethylene azelate polyol, polyethylene sebacate polyol, polypropylene sebacate polyol, polybutylene sebacate polyol, polyhexamethylene sebacate polyol, polyneopentyl sebacate polyol, polycyclohexanedimethylene sebacate polyol, polyol of diethylene glycol/terephthalic acid, polyol of polyethylene glycol/terephthalic acid, polyol of diethylene glycol/phthalic acid or phthalic anhydride, polyol of polyethylene glycol/phthalic acid or phthalic anhydride, polyol of diethylene glycol/isophthalic acid, polyol of polyethylene glycol/isophthalic acid, and their copolyester polyols.

More preferred examples of liquid polyester polyols include polycaprolactone polyol, polyethylene adipate polyol, polypropylene adipate polyol, polybutylene adipate polyol, polyhexamethylene adipate polyol, polycyclohexanedimethylene adipate polyol, polyethylene succinate polyol, polybutylene succinate polyol, polyol of diethylene glycol/terephthalic acid, polyol of polyethylene glycol/terephthalic acid, polyol of diethylene glycol/phthalic acid or phthalic anhydride, polyol of polyethylene glycol/phthalic acid or phthalic anhydride, polyol of diethylene glycol/isophthalic acid, polyol of polyethylene glycol/isophthalic acid, and the copolyesters of the terephthalates, isophthalates, and/or phthalates of diethylene glycol and/or polyethylene glycol with optional use of glycerol and/or trimethylol propane when average hydroxyl functionality greater than 2.0 is desired. Most preferred examples of liquid polyester polyols include polyol of diethylene glycol/terephthalic acid, polyol of polyethylene glycol/terephthalic acid, polyol of diethylene glycol/phthalic acid or phthalic anhydride, polyol of polyethylene glycol/phthalic acid or phthalic anhydride, polyol of diethylene glycol/isophthalic acid, polyol of polyethylene glycol/isophthalic acid, and the copolyesters of the terephthalates, isophthalates, and/or phthalates of diethylene glycol and/or polyethylene glycol with optional use of glycerol and/or trimethylol propane when average hydroxyl functionality greater than 2.0 is desired. For the various embodiments, the polyester polyol can also be uncapped or capped using ethylene oxide (EO) and/or propylene oxide (PO), as known in the art, so as to provide hydrophilic or hydrophobic structures. Examples of other liquid polyester polyols include modified aromatic polyester polyols such as those provided under the trade designator STEPANPOL PS-2352 (acid number 0.6-1.0 mg KOH/g, hydroxyl number 230-250 mg KOH/g, hydroxyl functionality 2.0, Stepan Company). The liquid polyester polyols may also contain a proportion of carboxyl end groups. Liquid polyester polyols formed with lactones, such as ε-caprolactone, or hydroxycarboxylic acids, such as 6-hydroxycaproic acid, may also be used.

The liquid polyether polyol can include those having at least 2, such as 2 or 3 hydroxyl groups per molecule and may be prepared, for example, by polymerization of oxiranes/cyclic ethers, such as ethylene oxide, propylene oxide, butylene oxide, styrene oxide or epichlorohydrin, either on their own, in the presence of BF3, or by a process of chemical addition of these oxiranes, optionally as mixtures (such as mixtures of ethylene oxide and propylene oxide) or successively, to starting components having reactive hydrogen atoms, such as water, ammonia, alcohols, or amines. Examples of suitable starting components include ethylene glycol, propylene glycol-(1,3) or -(1,2), glycerol, trimethylolpropane, 4,4′-dihydroxy-diphenylpropane, Novolac, aniline, ethanolamine or ethylenediamine. Sucrose-based polyether polyols may also be used. It is in many cases preferred to use polyethers which contain predominant amounts of primary OH groups (up to 100% of the OH groups present in the polyether). The polyether polyol or copolyether polyol should have a nominal functionality of at least 2.0. The nominal functionality preferably is 2.5 to 8, more preferably 2.5 to 7 or 2.5 to 6. The hydroxyl equivalent weight of the polyether polyol or copolyether polyol is at least 85, preferably at least 100, more preferably 150 to 3,200, in some embodiments 250 to 3,000 and in particular embodiments from 300 to 2,500. The polyol can also be formed of a blend, where the blend includes a blend of the diol and triol. The diol can have a number average molecular weight (Mn) of 200 to 8,000 grams/mole and a triol having an average number molecular weight (Mn) of 250 to 6,500 grams/mole. Other examples of suitable polyether polyols include those polymers or copolymers formed with propylene oxide that have a hydroxyl equivalent weight of at least 75. The propylene oxide may be 1,3-propylene oxide, but more typically is 1,2-propylene oxide. If a copolymer, the comonomer is another copolymerizable alkylene oxide such as, for example, ethylene oxide, 2,3-butylene oxide, tetrahydrofuran, 1,2-hexane oxide, and the like. A copolymer may contain 25% or more by weight, 50% or more by weight, and preferably 75% or more by weight polymerized propylene oxide, based on the total weight of polymerized alkylene oxides. A copolymer preferably contains no more than 75%, especially no more than 50% by weight polymerized ethylene oxide.

In various embodiments, the polyol can have a hydroxyl number of from 10 mg KOH/g to 700 mg KOH/g. In still other embodiments, the polyol has a hydroxyl number of from 20 mg KOH/g to 500 mg KOH/g, or from 30 mg KOH/g to 350 mg KOH/g. As used herein, a hydroxyl number is the milligrams of potassium hydroxide equivalent to the hydroxyl content in one gram of the polyol or other hydroxyl compound. The polyol can also have a number averaged isocyanate reactive group functionality of 1.8 to 6, such as 2 to 4 or 2.2 to 3.0.

For the various embodiments, the polyether polyol and/or a polyester polyol can also be uncapped or capped using ethylene oxide (EO) and/or propylene oxide (PO), as known in the art, so as to provide hydrophilic or hydrophobic structures.

For the various embodiments, the liquid transition metal chelating polyol blend includes 0.05 weight percent (wt. %) to 10.0 wt. % of the transition metal ion from the transition metal compound, the wt. % based on the total weight of the liquid transition metal chelating polyol blend. The liquid transition metal chelating polyol blend can also include 0.15 wt. % to 6.0 wt. % of the transition metal ion from the transition metal compound, or from 0.5 wt. % to 3.0 wt. % of the transition metal ion from the transition metal compound the wt. % based on the total weight of the liquid transition metal chelating polyol blend.

For the embodiments, the transition metal compound is selected from the group consisting of a transition metal carboxylate, a transition metal salt, a transition metal coordinate compound, and combinations thereof and the transition metal ion is selected from the periodic table transition metals of Group 4, 5, 6, 7, 8, 9, 10, 11, 12 and Period 4, 5 and combinations thereof (IUPAC Periodic Table of the Elements, 28 Nov. 2016). Preferably the transition metal compound is a transition metal carboxylate. Preferably, the transition metal ion is selected from the group consisting of a transition metal ion of copper, zinc, silver, iron, manganese, cobalt, nickel, zirconium cadmium, mercury, palladium, titanium, vanadium and combinations thereof. More preferably, the transition metal ion is selected from the group consisting of a transition metal ion of copper, zinc, silver, iron, manganese, cobalt, nickel, zirconium and combinations thereof. Most preferably, the transition metal ion is selected from the group consisting of a transition metal ion of copper, zinc, iron, manganese, cobalt, nickel, and combinations thereof. Examples of the transition metal compound include copper (II) 2-ethylhexanotate, copper (II) acetate, copper (II) acetate monohydrate (CMOAc)₂H₂O), copper (I) acetate, copper butyrate, di-μ-hydroxo-bis[(N,N,N′,N′-tetramethylethylenediamine)copper(II)] chloride, zinc stannate, zinc hydroxystannate, zinc (II) acetate, cobalt (II) acetate, nickel (II) acetate, silver (I) acetate, manganese (II) 2-ethylhexanoate, and combinations thereof. Preferably, the transition metal compound is selected from the group consisting of copper (II) 2-ethylhexanoate (CuEH), copper (II) acetate, copper (II) acetate monohydrate (Cu(OAc)₂ copper(II)propionate, copper (II) isobutyrate (Cu(i-Bu)₂), cobalt (II) acetate, nickel (II) acetate, silver (I) acetate and combinations thereof.

For the embodiments, the chelating agent having a nitrogen based chelating moiety is selected from the group consisting of a diamine chelating moiety, a triamine chelating moiety, a tetraamine chelating moiety and combinations thereof. For some embodiments, the chelating agent having a nitrogen based chelating moiety is selected from tertiary polyamino compounds with at least two tertiary nitrogens connected through carbon atoms. The chelating agent preferably can conform to the Formula I

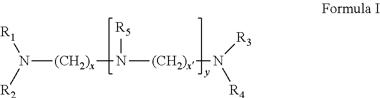

where R₁, R₂, R₃, R₄, and R₅ are each independently an alkyl group of C1 to C8, an alkoxylate/polyalkoxylate (i.e., —(CH₂CHRO)ₙ—H, where R is H or an alkyl group of C1 to C3 and n is integer from 1 to 10) and their equivalents, x and x′ are each independently integers of 2 or 3, and y is an integer of 0, 1, or 2. More preferably for Formula I, R₁, R₂, R₃, R₄, and R₅ are each independently an alkyl group of C1 to C3, an alkoxylate/polyalkoxylate as provided above where the alkyl group is C1 to C2, x and x′ are each independently an integer of 2 or 3, and y is an integer of 0 or 1. Most preferably for Formula I, R₁, R₂, R₃, R₄, and R₅ are each independently an alkyl group of C1 to C3, an alkoxylate/polyalkoxylate as provided above where the alkyl group is C1, x and x′ are an integer of 2, and y is an integer of 0 or 1.

For the embodiments, the chelating agent having a nitrogen based chelating moiety can further have an isocyanate reactive moiety. Preferred chelating agents having a nitrogen based chelating moiety are diamines, triamines, and tetraamines in which the amine moieties are tertiary amines.

Examples of the chelating agent having a diamine chelating moiety for the nitrogen based chelating moiety include 2,2′-bipyridine, N,′,N,N′-tetramethylethylediamine, N,N,N,N′-tetraethylethylenediamine, triethylenediamine (1,4-diazabicyclo[2.2.2]octane), N,N′-dimethylaminoethyl-N-methylethanolamine, N, N′-dimethylaminoethylmorpholine, N,N,N′,N′-tetramethyl-1,3-butanediamine, N,N′-dimethylpiperazine, methylhydroxyethylpiperazine, N,N,N′,N′-tetrakis-(2-hydroxypropyl)ethylenediamine, 2-[[2-(dimethylamino)ethyl]methylamino]ethanol, N,N,N′-trimethyl-N′-hydroxylethyl-bis(amino ethyl) ether; N,N-bis(3-dimethylamino-propyl)-N-isopropanolamine; Bis-(dimethylaminopropyl)amino-2-propanol; N,N,N′-trimethylaminopropyl ethanolamine, a 1,2-ethanediamine polymer with methyl oxirane and combinations thereof. Examples of the chelating agent having a triamine chelating moiety for the nitrogen based chelating moiety include VORANOL™ RA 640 a 1,2-ethanediamine polymer with methyl oxirane (available from DOW Inc.), N,N,N′,N′,N″-pentamethyldiethylenetriamine, N,N,N′,N′,N″-pentamethyldipropylenetriamine, 1-[bis[3-(dimethylamino)propyl]amino-2-propanol], N,N′-dimethylaminoethyl(N-methylpiperzine) and combinations thereof. Examples of the chelating agent having a tetramine chelating moiety for the nitrogen based chelating moiety include 1,1,4,7,10,10-hexamethyltriethylenetetramine, tris[2-(dimethylamino)ethyl]amine, tris[2-(isopropylamino)ethyl]amine, and combinations thereof. Preferably, the chelating agent having a nitrogen based chelating moiety is selected from the group consisting of 2,2′-bipyridine, N,N,N,N′-tetramethytethylenediamine, N,N,N′,N′,N″-pentamethyldiethylenetriamine, 2-[[2-(dimethylamino)ethyl] methylamino]ethanol, 1-[bis[3-(dimethylamino)propyl]amino-2-propanol, a 1,2-ethanediamine polymer with methyl oxirane (e.g., VORANOL™ RA 640) and combinations thereof.

In various embodiments, the chelating agent having a nitrogen based chelating moiety is soluble in the polyol in the transition metal chelating polyol blend where the liquid transition metal chelating polyol blend has 0.001 to 1.0 moles of nitrogen in the nitrogen based chelating moiety per 100 g of the polyol in the liquid transition metal chelating polyol blend, preferably 0.003 to 0.60 moles of nitrogen in the nitrogen based chelating moiety per 100 g of polyol in the liquid transition metal chelating polyol blend, more preferably 0.006 to 0.40 moles of nitrogen in the nitrogen based chelating moiety per 100 g of polyol in the liquid transition metal chelating polyol blend and most preferably 0.01 to 0.20 moles of nitrogen in the nitrogen based chelating moiety per 100 g of polyol in the liquid transition metal chelating polyol blend.

The liquid transition metal chelating polyol blend has a molar ratio of nitrogen in the nitrogen based chelating moiety to the transition metal ion of 8:0:1:0 to 1.0:1.0 (moles nitrogen:moles of transition metal ion), where for the various embodiments the molar ratio of nitrogen in the nitrogen based chelating moiety to the transition metal ion is preferably 4.0:1.0 to 1.0:1.0 (moles nitrogen:moles of transition metal ion), more preferably a molar ratio of nitrogen in the nitrogen based chelating moiety to the transition metal ion of 2.8:1.0 to 1.0:1.0 (moles nitrogen:moles of transition metal ion), most preferably a molar ratio of nitrogen in the nitrogen based chelating moiety to the transition metal ion of 2.0:1.0 to 1.0:1.0 (moles nitrogen:moles of transition metal ion).

In various embodiments, the liquid transition metal chelating polyol blend in the present disclosure have little or no impact on the reaction of the isocyanate and the isocyanate-reactive composition. For a PIR system, the liquid transition metal chelating polyol blend preferably does not reduce the isocyanurate content by 50% or more in the polyurethane foam as compared to the same polyurethane foam formulation without the transition metal compound. More preferably, the transition metal compound does not reduce the isocyanurate content by 40% or more in the polyurethane foam as compared to the same polyurethane foam formulation without the transition metal compound. More preferably, the transition metal compound does not reduce the isocyanurate content by 30% or more in the polyurethane foam as compared to the same polyurethane foam formulation without the transition metal compound. Most preferably, the transition metal compound does not reduce the isocyanurate content by 25% or more in the polyurethane foam as compared to the same polyurethane foam formulation without the transition metal compound.

The present disclosure provides for a process for preparing a liquid transition metal chelating polyol blend, where the process includes providing the polyol; providing the chelating agent having the nitrogen based chelating moiety and providing the transition metal compound having a transition metal ion. The process further includes admixing the polyol, the chelating agent and the transition metal compound to form the liquid transition metal chelating polyol blend having 0.001 to 1.0 moles of nitrogen in the nitrogen based chelating moieties per 100 g of the polyol in the liquid transition metal chelating polyol blend. For the various embodiments, the liquid transition metal chelating polyol blend has a molar ratio of nitrogen in the nitrogen based chelating moiety to the transition metal ion of 8:0:1:0 to 1.0:1.0 (moles nitrogen:moles of transition metal ion), where for the various embodiments the molar ratio of nitrogen in the nitrogen based chelating moiety to the transition metal ion is preferably 4.0:1.0 to 1.0:1.0 (moles nitrogen:moles of transition metal ion), more preferably a molar ratio of nitrogen in the nitrogen based chelating moiety to the transition metal ion of 2.8:1.0 to 1.0:1.0 (moles nitrogen:moles of transition metal ion), most preferably a molar ratio of nitrogen in the nitrogen based chelating moiety to the transition metal ion of 2.0:1.0 to 1.0:1.0 (moles nitrogen:moles of transition metal ion). For the various embodiments, the admixing can take place at atmospheric pressure (e.g., 101.23 KPa) and a temperature lower than 100° C., preferably lower than 80° C., more preferably lower than 60° C., and most preferably lower than 40° C. to form the liquid transition metal chelating polyol blend.

The present disclosure also provides for an isocyanate-reactive composition that includes the liquid transition metal chelating polyol blend as provided herein, optionally a catalyst and a flame retardant where the isocyanate-reactive composition can be used in forming a polyurethane polymer. Embodiments of the present disclosure also include the isocyanate-reactive composition having the liquid transition metal chelating polyol blend as provided herein, and further include a polyol (separate from the polyol in the liquid transition metal chelating polyol blend), a phosphorus flame retardant, a catalyst, a blowing agent, water, a surfactant or a combination thereof, where the isocyanate-reactive composition can be used in forming a polyurethane foam. For example, the isocyanate-reactive composition as provided herein can include a blowing agent and a surfactant for use in forming a polyurethane polymer foam. Amounts (e.g., wt. % values) of each of the catalyst, the water, the surfactant, the flame retardant and the blowing agent useful in the isocyanate-reactive composition, along with the examples for each, are provided herein in the context of the reaction mixture for forming the polyurethane polymer of the present disclosure, discussed herein below.

For the various embodiments, the isocyanate-reactive composition can further include a polyol separate from the polyol in the liquid transition metal chelating polyol blend, where the isocyanate-reactive composition includes 0.1 to 100 weight percent (wt. %) of the liquid transition metal chelating polyol blend and up to 99.9% of the polyol separate from the polyol of the liquid transition metal chelating polyol blend to form the isocyanate-reactive composition for a polyurethane polymer, the wt. % based on the total weight of the isocyanate-reactive composition. For the various embodiments, the polyol used with the liquid transition metal chelating polyol blend to help form the isocyanate-reactive composition can be selected from the group consisting of a polyester polyol, polyether polyol, polycarbonate polyol, a polyethercarbonate polyol and combinations thereof.

The polyol separate from the polyol in the liquid transition metal chelating polyol blend can have a number average molecular weight of 100 g/mol to 10,000 g/mol. Other number average molecular weight values may also be possible. For example, the polyol can have a number average molecular weight from a low value of 100, 200, 300, 350 or 400 g/mol to an upper value of 500, 750, 1,000, 2,000 or 10,000 g/mol. The number average molecular weight values reported herein are determined by end group analysis, gel permeation chromatography, and other methods as is known in the art. The polyol used with the liquid transition metal chelating polyol blend to help form the isocyanate-reactive composition can also include an aromatic moiety. As used herein, an “aromatic moiety” is at least one cyclically conjugated molecular moiety in the form of a planar unsaturated ring of carbon atoms that is covalently attached to the polyol compound. The planar unsaturated ring of carbon atoms can have at least six (6) carbon atoms.

For the embodiments, the isocyanate-reactive composition can further include 0.1 wt. % to 7.0 wt. % of phosphorus from a flame-retardant compound, where the wt. % of phosphorus is based on the overall weight of the isocyanate-reactive composition. Preferably, the isocyanate-reactive composition includes 0.5 wt. % to 5.0 wt. % of phosphorus from the flame-retardant compound (the wt. % of phosphorus based on the overall weight of the isocyanate-reactive composition). More preferably, the isocyanate-reactive composition includes 1.0 wt. % to 3.0 wt. % of phosphorus from the flame-retardant compound (the wt. % of phosphorus based on the overall weight of the isocyanate-reactive composition). The isocyanate-reactive composition can further include 0.05 wt. % to 10.0 wt. % of the transition metal, where the transition metal is from the transition metal compound having the transition metal ion, as provided herein, and the wt. % of the transition metal is based on the total weight of the liquid transition metal chelating polyol blend. Preferably, the isocyanate-reactive composition can further include 0.15 wt. % to 6.0 wt. % of the transition metal from the transition metal compound having the transition metal ion, as provided herein (the wt. % of the transition metal based on the total weight of the liquid transition metal chelating polyol blend), and most preferably 0.5 wt. % to 3.0 wt. % of the transition metal from the transition metal compound having the transition metal ion, as provided herein (the wt. % of the transition metal based on the total weight of the liquid transition metal chelating polyol blend). For the given weight percent values, the isocyanate-reactive composition can have a molar ratio of the transition metal ion to phosphorus (mole transition metal ion:mole phosphorous) of 0.05:1 to 5:1. Preferably, the molar ratio of the transition metal ion to phosphorus (mole transition metal:mole phosphorous) is 0.1:1 to 2:1. More preferably, the molar ratio of the transition metal ion to phosphorus (mole transition metal:mole phosphorous) is 0.5:1 to 1:1.

For the embodiments provided herein, the isocyanate-reactive composition can have a flame retardant compound, preferably a halogen-free flame-retardant compound, selected from the group consisting of a phosphate, a phosphonate, a phosphinate, a phosphite and combinations thereof. Examples of the phosphate include trialkyl phosphate, triaryl phosphate, a phosphate ester and resorcinol bis(diphenyl phosphate). As used herein, a trialkyl phosphate has at least one alkyl group with 2 to 12 carbon atoms. The other two alkyl groups of the trialkyl phosphate may, independently be the same or different than the first alkyl group, containing from one to 8 carbon atoms, including a linear or branched alkyl group, a cyclic alkyl group, an alkoxyethyl, a hydroxylalkyl, a hydroxyl alkoxyalkyl group, and a linear or branched alkylene group. Examples of the other two alkyl groups of the trialkyl phosphate include, for example, methyl, ethyl, propyl, butyl, n-propyl, isopropyl. n-butyl, isobutyl, sec-butyl, tert-butyl, butoxyethyl, isopentyl, neopentyl, isohexyl, isoheptyl, cyclohexyl, propylene, 2-methylpropylene, neopentylene, hydroxymethyl, hydroxyethyl, hydroxypropyl or hydroxybutyl. Blends of different trialkyl phosphates may also be used. The three alkyl groups of the trialkyl phosphate may be the same. The alkyl groups can be halogenated alkyl groups, preferably the alkyl groups are halogen-free alkyl groups. The trialkyl phosphate can be tris(2-chloro-1-methylethyl) phosphate (TCPP), tris[2-chloro-1-(chloromethyl)ethyl] phosphate (TDCP), tris(p-tertiary-butylphenyl) phosphate (TBPP), and tris(2-chloroethyl) phosphate (TCEP). The trialkyl phosphate is desirably triethyl phosphate (TEP).

Examples of the phosphonate include diethyl (hydroxymethyl)phosphonate, dimethyl methyl phosphonate and diethyl ethyl phosphonate. Examples of the phosphinate include a metal salt of organic phosphinate such as aluminum methylethylphosphinate, aluminum diethylphosphinate, zinc methylethylphosphinate, and zinc diethylphosphinate. Examples of additional halogen-free flame-retardant compounds include resorcinoldiphosphoric acid, 9,10-dihydro-9-oxa-10-phosphaphenanthrene-10-oxide, ammonium polyphosphate and combinations thereof.

The present disclosure also provides for a reaction mixture for forming a polyurethane polymer. The reaction mixture includes an isocyanate compound having an isocyanate moiety and the isocyanate-reactive composition having hydroxyl moieties (e.g., from the polyester polyol) as provided herein, where the reaction mixture has a molar ratio of the isocyanate moiety to the hydroxyl moiety of 0.90:1 to 7:1. For polyurethane rigid (PUR) and polyisocyanurate (PIR) preferably, the molar ratio of the isocyanate moiety to the hydroxyl moiety is 1.2:1 to 7:1, more preferably, the molar ratio of the isocyanate moiety to the hydroxyl moiety is 1.5:1 to 5:1, and most preferably, the molar ratio of the isocyanate moiety to the hydroxyl moiety is 2:1 to 4:1. For flexible polyurethane foams, preferably the molar ratio of the isocyanate moiety to the hydroxyl moiety is 0.90:1 to 1.20:1, more preferably the molar ratio of the isocyanate moiety to the hydroxyl moiety is 0.95:1 to 1.15:1, most preferably the molar ratio of the isocyanate moiety to the hydroxyl moiety is 1:1 to 1.10:1. For two component polyurethane adhesives, sealants, coatings, and elastomers, preferably the molar ratio of the isocyanate moiety to the hydroxyl moiety is 0.95:1 to 1.35:1, more preferably the molar ratio of the isocyanate moiety to the hydroxyl moiety is 0.98:1 to 1.10:1, most preferably the molar ratio of the isocyanate moiety to the hydroxyl moiety is 1:1 to 1.05:1.

For the various embodiments, the isocyanate compound has a number average molecular weight of 150 g/mol to 750 g/mol. Other number average molecular weight values may also be possible. For example, the isocyanate reactive compound can have a number average molecular weight from a low value of 150, 200, 250 or 300 g/mol to an upper value of 350, 400, 450, 500, or 750 g/mol. In some embodiments, when the isocyanate compound is an isocyanate prepolymer resulting from reaction of a isocyanate reactive compound with a molar excess of a polyisocyanate compound or polymeric isocyanate compound under conditions that do not lead to gelation or solidification, the isocyanate prepolymers can have a higher number average molecular weight than 750 g/mol and can be calculated from the number average molecular weight of each component and their relative masses used in preparing the prepolymer. The number average molecular weight values reported herein are determined by end group analysis, gel permeation chromatography, and other methods as is known in the art. The isocyanate compound can be monomeric and/or polymeric, as are known in the art. In addition, the isocyanate compound can have an isocyanate equivalent weight of 80 to 1750. In certain embodiments, the isocyanate has a viscosity, at 25° C., of 5 to 50,000 mPa·s, when measured using a Brookfield DVE viscometer. Other viscosity values may also be possible. For example, the isocyanate reactive compound can have a viscosity value from a low value of 5, 10, 30, 60 or 150 mPa's to an upper value of 500, 2500, 10,000 or 50,000 mPa's, each measured at 25° C. using a Brookfield DVE viscometer.

As used herein, polymeric isocyanate compounds contain two or more than two —NCO groups per molecule and which are also considered isocyanate compounds. For the various embodiments, the polymeric isocyanate compound is selected from an aliphatic diisocyanate, a cycloaliphatic diisocyanate, an aromatic diisocyanate, a polyisocyanate, an isocyanate prepolymer and combinations thereof. For the various embodiments, the polymeric isocyanate compound has a number average molecular weight of 150 g/mol to 750 g/mol. In addition, the polymeric isocyanate compound can have an isocyanate equivalent weight of 80 to 150, preferably of 100 to 145 and more preferably of 110 to 140 with the so-called MDI products, which are a mixture of isomers of diphenylmethanediisocyanate (MDI) in monomeric MDI or the so-called polymeric MDI products, which are a mixture of polymethylene polyphenylene polyisocyanates in monomeric MDI.

Examples of the polymeric isocyanate compound of the present disclosure can include, but is not limited to, methylene diphenyldiisocyanate (MDI), polymethylene polyphenylisocyanate containing MDI, polymeric MDI (PMDI), 1,6 hexamethylenediisocyanate (HDI), 2,4- and/or 2,6-toluenediisocyanate (TDI), 1,5-naphthalene diisocyanate (NDI), tetramethylene-1,4-diisocyanate, cyclohexane-1,4-diisocyanate, hexahydrotoluene diisocyanate, hydrogenated MDI (H₁₂ MDI), methoxyphenyl-2,4-diisocyanate, 4,4′-biphenylene diisocyanate, 3,3′-dimethyoxy-4,4′-biphenyl diisocyanate, 3,3′-dimethyldiphenylmethane-4,4′-diisocyanate, 4,4′,4″-triphenylmethane diisocyanate, polymethylene polyphenylisocyanates, hydrogenated polymethylene polyphenyl polyisocyanates, toluene-2,4,6-triisocyanate and 4,4′-dimethyldiphenylmethane-2,2′,5,5′-tetraisocyanate, methylene bicyclohexylisocyante (HMDI), isophoronediisocyanate (IPDI) and combinations thereof. Suitable isocyanates can also include other aromatic and/or aliphatic polyfunctional isocyanates. Aromatic diisocyanates include those containing phenyl, tolyl, xylyl, naphthyl, or diphenyl moiety, or a combination thereof, such as trimethylol propane-adducts of xylylene diisocyanate, trimethylol propane-adducts of toluene diisocyanate, 4,4′-diphenyldimethane diisocyanate (MDI), xylylene diisocyanate (XDI), 4,4′-diphenyldimethylmethane diisocyanate, di- and tetraalkyldiphenylmethane diisocyanate, 4,4′-dibenzyl diisocyanate, 1,3-phenylene diisocyanate, 1,4-phenylene diisocyanate, and a combination thereof. Suitable aliphatic polymeric isocyanate compounds include trimers of hexamethylene diisocyanate, trimers of isophorone diisocyanate, biurets of hexamethylene diisocyanate, hydrogenated polymeric methylene diphenyl diisocyanate, hydrogenated methylene diphenyl diisocyanate, hydrogenated MDI, tetramethylxylol diisocyanate (TMXDI), 1-methyl-2,4-diisocyanato-cyclohexane, 1,6-diisocyanate-2,2,4-trimethylhexane, 1-isocyanatomethyl-3-isocyanato-1,5,5-trimethylcyclohexane,tetramethoxybutane 1,4-diisocyanate, butane 1,4-diisocyanate, hexane 1,6-diisocyanate, dicyclohexylmethane diisocyanate, cyclohexane 1,4-diisocyanate, and a combination thereof. Examples of other polymeric isocyanate compounds include additional aliphatic, cycloaliphatic, polycyclic or aromatic in nature such as hydrogenated xylene diisocyanate (HXDI), p-phenylene diisocyanate (PPDI), 3,3′-dimethyldiphenyl-4,4′-diisocyanate (DDDI), 2,2,4-trimethylhexamethylene diisocyanate (TMDI), isophorone diisocyanate (IPDI), 4,4′-dicyclohexylmethane diisocyanate (H12MDI) and norbornane diisocyanate (NDI). As well as the isocyanates mentioned above, partially modified polyisocyanates including uretdione, isocyanurate, carbodiimide, uretonimine, allophanate or biuret structure, and combinations thereof, among others, may be utilized. The polyols as provided herein may be pre-reacted with the organic polyisocyanate to form a prepolymer or quasi-prepolymer which contains isocyanate groups. The prepolymer or quasi-prepolymer may have an isocyanate content of, for example, 1 to 20 percent by weight. The isocyanate content in some embodiments is at least 2.5% or at least 4% and up to 15%, up to 12% or up to 10%.

In addition to providing for the reaction mixture, the present disclosure also provides for a process for preparing the reaction mixture for producing a polyurethane polymer. As discussed herein, the reaction mixture for forming the polyurethane polymer includes the isocyanate compound having the isocyanate moiety and the isocyanate-reactive composition, as discussed herein, where the polyol includes a hydroxyl moiety, and the reaction mixture has a molar ratio of the isocyanate moiety to the hydroxyl moiety of 0.90:1 to 7:1 (among the others values as discussed herein). The process for preparing the reaction mixture for producing the polyurethane polymer includes providing the isocyanate-reactive composition, as provided herein; providing the isocyanate compound having the isocyanate moiety, as provided herein, and admixing the isocyanate-reactive composition and the isocyanate compound to form the reaction mixture having a molar ratio of the isocyanate moiety to the hydroxyl moiety of 0.90:1 to 7:1 (among the others values as discussed herein). Admixing the isocyanate-reactive composition and the isocyanate compound can further include admixing water, a catalyst, a surfactant, a blowing agent, a phosphorous containing flame-retardant compound, and combinations thereof with the reaction mixture to form a polyurethane polymer including the subset of a polyurethane polymer foam. The result of the process can be a polyurethane polymer or a polyurethane polymer foam formed with the reaction mixture, as provided herein.

For the various embodiments provided herein, the catalyst can be present in the reaction mixture an amount of 0.01 to 1.5 wt. % based on the total weight of the reaction mixture. The catalyst can be selected from the group consisting of an organic tertiary amine, tertiary phosphines, potassium acetates, a urethane-based catalyst and combinations. The catalyst can also include organo-tin compounds, as are known in the art.

The catalyst may be a blowing catalyst, a gelling catalyst, a trimerization catalyst, or combinations thereof. As used herein, blowing catalysts and gelling catalysts, may be differentiated by a tendency to favor either the urea (blow) reaction, in the case of the blowing catalyst, or the urethane (gel) reaction, in the case of the gelling catalyst. A trimerization catalyst may be utilized to promote the isocyanurate reaction in the compositions. Blowing catalysts and gelling catalysts are both utilized in preparation of rigid and flexible polyurethane foams. Polyurethanes that are not foams or microcellular such as many coatings, adhesives, sealants and elastomers utilize gelling catalysts.

Examples of blowing catalysts, e.g., catalysts that may tend to favor the blowing reaction include, but are not limited to, short chain tertiary amines or tertiary amines containing an oxygen. The amine-based catalyst may not be sterically hindered. For instance, blowing catalysts include bis-(2-dimethylaminoethyl)ether; pentamethyldiethylene-triamine, triethylamine, tributyl amine, N,N-dimethylaminopropylamine, dimethylethanolamine, N,N,N′,N′-tetra-methylethylenediamine, and combinations thereof, among others. An example of a commercial blowing catalyst is POLYCAT™ 5, from Evonik, among other commercially available blowing catalysts.

Examples of gelling catalysts, e.g., catalyst that may tend to favor the gel reaction, include, but are not limited to, organometallic compounds, cyclic tertiary amines and/or long chain amines, e.g., that contain several nitrogen atoms, and combinations thereof. Organometallic compounds include organotin compounds, such as tin(II) salts of organic carboxylic acids, e.g., tin(II) diacetate, tin(II) dioctanoate, tin(II) diethylhexanoate, and tin(II) dilaurate, and dialkyltin(IV) salts of organic carboxylic acids, e.g., dibutyltin diacetate, dibutyltin dilaurate, dibutyltin maleate and dioctyltin diacetate. Bismuth salts of organic carboxylic acids may also be utilized as the gelling catalyst, such as, for example, bismuth octanoate. Cyclic tertiary amines and/or long chain amines include dimethylbenzylamine, triethylenediamine, and combinations thereof, and combinations thereof. Examples of a commercially available gelling catalysts are POLYCAT™ 8 and DABCO® T-12 from Evonik, among other commercially available gelling catalysts.

Examples of trimerization catalysts include N,N,N′,N″,N″-pentamethyldiethylenetriamine (PMDETA); N,N′,N″-tris(3-dimethylaminopropyl)hexahydro-S-triazine; N,N-dimethylcyclo-hexylamine; 1,3,5-tris(N,N-dimethylaminopropyl)-s-hexahydrotriazine; [2,4,6-Tris (dimethylaminomethyl) phenol]; potassium acetate, potassium octoate; tetraalkylammonium hydroxides such as tetramethylammonium hydroxide; alkali metal hydroxides such as sodium hydroxide; alkali metal alkoxides such as sodium methoxide and potassium isopropoxide; and alkali metal salts of long-chain fatty acids having 10 to 20 carbon atoms and, combinations thereof, among others. Some commercially available trimerization catalysts include DABCO® TMR-2, TMR-7, DABCO® K 2097; DABCO® K15, POLYCAT™ 41, and POLYCAT™ 46, each from Evonik, among other commercially available trimerization catalysts.

For the various embodiments provided herein, the water can be present in the reaction mixture in an amount of 0.1 to 1.5 wt. % based on the total weight of the reaction mixture.

For the various embodiments, the surfactant agent can be present in the reaction mixture in an amount of 0.1 to 10 wt. % based on the total weight of the reaction mixture. Examples of suitable surfactants include silicone-based surfactants and organic-based surfactants. Some representative materials are, generally, polysiloxane polyoxylalkylene block copolymers, such as those disclosed in U.S. Pat. Nos. 2,834,748; 2,917,480; and 2,846,458, the disclosures of which are incorporated herein by reference in their entireties. Also included are organic surfactants containing polyoxyethylene-polyoxybutylene block copolymers, as are described in U.S. Pat. No. 5,600,019, the disclosure of which is incorporated herein by reference in its entirety. Other surfactants include polyethylene glycol ethers of long-chain alcohols, tertiary amine or alkanolamine salts of long-chain allyl acid sulfate esters, alkylsulfonic esters, alkyl arylsulfonic acids and combinations thereof.

For the various embodiments, the blowing agent can be present in the reaction mixture for forming the polyurethane polymer foam in an amount of 1.0 to 15 wt. % based on the total weight of the reaction mixture. In addition to the other blowing agents provided herein, blowing agents, as are known in the art, can be selected from the group consisting of water, volatile organic substances, dissolved inert gases and combinations thereof. Examples of blowing agents include hydrocarbons such as butane, isobutane, 2,3-dimethylbutane, n- and i-pentane isomers, hexane isomers, heptane isomers and cycloalkanes including cyclopentane, cyclohexane, cycloheptane; hydroflurocarbons such as HCFC-142b (1-chloro-1,1-difluoroethane), HCFC-141b (1,1-dichloro-1-fluoroethane), HCFC-22 (chlorodifluoro-methane), HFC-245fa (1,1,1,3,3-pentafluoropropane), HFC-365mfc (1,1,1,3,3-penta-fluorobutane), HFC 227ea (1,1,1,2,3,3,3-heptafluoropropane), HFC-134a (1,1,1,2-tetrafluoroethane), HFC-125 (1,1,1,2,2-pentafluoroethane), HFC-143 (1,1,2-trifluoroethane), HFC 143A (1,1,1-trifluoroethane), HFC-152 (1,1-difluoroethane), HFC-227ea (1,1,1,2,3,3,3-heptafluoropropane), HFC-236ca(1,1,2,2,3,3-hexafluoropropane), HFC 236fa (1,1,1,3,3,3-hexafluoroethane), HFC 245ca (1,1,2,2,3-pentafluoropentane), HFC 356mff (1,1,1,4,4,4-hexafluorobutane), HFC 365mfc (1,1,1,3,3-pentafluorobutane); hydrofluoroolefins such as cis-1,1,1,4,4,4-hexafluoro-2-butene, 1,3,3,3-Tetrafluoropropene, trans-1-chloro-3,3,3-trifluoropropene; a chemical blowing agent such as formic acid and water. The blowing agent can be other volatile organic substances such as ethyl acetate; methanol; ethanol; halogen substituted alkanes, such as methylene chloride, chloroform, ethylidene chloride, vinylidene chloride, monofluorotrichloromethane, chlorodifluoromethane or dichlorodifluoromethane; butane; hexane; heptane; diethyl ether as well as gases such as nitrogen; air; and carbon dioxide.

The reaction mixture can further include a filler along with other additives in addition to water, a catalyst, a blowing agent, a surfactant and combinations thereof. The total amount of such other additives may be from 0.01 wt. % to 30.0 wt. %. The use of other additives for polyurethane polymer compositions are also known and may be used with the present disclosure.

As discussed herein, the liquid transition metal chelating polyol blend has a molar ratio of nitrogen in the nitrogen based chelating moiety to the transition metal ion of 8:0:1:0 to 1.0:1.0 (moles nitrogen:moles of transition metal ion), where for the various embodiments the molar ratio of nitrogen in the nitrogen based chelating moiety to the transition metal ion is preferably 4.0:1.0 to 1.0:1.0 (moles nitrogen:moles of transition metal ion), more preferably a molar ratio of nitrogen in the nitrogen based chelating moiety to the transition metal ion of 2.8:1.0 to 1.0:1.0 (moles nitrogen:moles of transition metal ion), most preferably a molar ratio of nitrogen in the nitrogen based chelating moiety to the transition metal ion of 2.0:1.0 to 1.0:1.0 (moles nitrogen:moles of transition metal ion). While other molar ratios of nitrogen in the nitrogen based chelating moiety to the transition metal ion can be used, it is desirable to maximize the amount of transition metal ion (e.g., copper) that can be delivered to the reaction mixture relative to nitrogen so that the reaction speed of isocyanate and isocyanate reactive moieties in the isocyanate-reactive composition or a reaction mixture for producing a polyurethane polymer and/or a polyurethane polymer foam of the present disclosure is not unduly impacted by the higher catalytical amine chelating agent content resulting from higher nitrogen to transition metal ion mole ratios such that in a foaming process the blowing, gelling, and/or trimerization reactions are unbalanced leading to foam with substantively reduced foam characteristics such as insulation characteristics, increased density, and/or other deficient foam attributes while the reaction kinetics parameters such as cream time, gel time, and tack free time fit within the processing parameters of the foaming process and associated equipment.

For the present embodiments, the reaction kinetics parameters of a polyurethane foam are determined for the reaction mixture provided herein using a wood tongue depressor. A total of 80 grams (g) of reaction mixture having an isocyanate compound and an isocyanate-reactive composition is poured into a 500 mL beaker. The cream time is defined as the time from the preparation of the reaction mixture until the recognizable beginning of the foaming mixture such as a visual change of the reactants (color change and/or start of rise) occurs. The gel time (or string time) is defined as the time from the preparation of the reaction mixture until the transition from the fluid to the solid state is reached. It is determined by repeatedly dipping and pulling out a wood tongue depressor into the reaction mixture. The gel time is reached as soon as strings are formed while pulling the wood tongue depressor out of the reaction mixture. The tack-free time is defined as the time from the preparation of the foam reaction mixture until the surface of the foam is tack free. It is determined by depositing a wood tongue depressor on the foam surface. The tack-free time is reached if lifting the wood tongue depressor does not lead to delamination or rupture of the foam surface, in other words, when the foam surface is not tacky anymore.

For various embodiments, the combination of a liquid transition metal chelating polyol blend and an optional catalyst provide reaction kinetics parameters for a polyurethane foam formulation comprising an isocyanate compound and an isocyanate-reactive composition similar to a typical same type of polyurethane foam formulation without the liquid transition metal chelating polyol blend. The foam system containing a liquid transition metal chelating polyol blend has a cream time preferably within 10 seconds, more preferably within 5 seconds, most preferably within 2 seconds compared to the cream time of a typical same type of polyurethane foam without the liquid transition metal chelating polyol blend. The foam system containing a liquid transition metal chelating polyol blend has a gel time preferably within 20 seconds, more preferably within 10 seconds, most preferably within 8 seconds compared to the gel time of a typical same type of polyurethane foam without the liquid transition metal chelating polyol blend. The foam system containing a liquid transition metal chelating polyol blend has a tack free time preferably within 20 seconds, more preferably within 10 seconds, most preferably within 8 seconds compared to the tack free time of a typical same type of polyurethane foam without the liquid transition metal chelating polyol blend.

For a typical PIR foam system with or without the liquid transition metal chelating polyol blend, the cream time is preferably within the range of 1 second to 20 seconds, more preferably within the range of 3 seconds to 15 seconds, even more preferably within the range of 5 seconds to 12 seconds, most preferably within the range of 6 seconds to 10 seconds. For a typical PIR foam system with or without the liquid transition metal chelating polyol blend, the gel time is preferably within the range of 15 second to 60 seconds, more preferably within the range of 18 seconds to 50 seconds, even more preferably within the range of 20 seconds to 40 seconds, most preferably within the range of 25 seconds to 35 seconds. For a typical PIR foam system with or without the liquid transition metal chelating polyol blend, the tack free time is preferably within the range of 30 second to 120 seconds, more preferably within the range of 40 seconds to 90 seconds, even more preferably within the range of 50 seconds to 80 seconds, most preferably within the range of 55 seconds to 70 seconds.

For the various embodiments, the reaction mixture can be used to form either a polyurethane polymer or a polyurethane polymer foam. Processes for preparing the reaction mixture for producing a polyurethane polymer or a polyurethane polymer foam can be achieved through any known process techniques in the art. In general, the polyurethane polymer foam of the present disclosure may be produced by discontinuous or continuous processes, including the process referred to generally as the discontinuous panel process (DCP) and continuous lamination, with the foaming reaction and subsequent curing being carried out in molds or on conveyors. The process of forming either the polyurethane polymer or the polyurethane polymer foam, as provided herein, can be performed at a temperature from 15° C. to 80° C. and a mixing pressure from 80 kPa to 25,000 kPa. The admixing of the components for the polyurethane foam can be performed using known mixing devices. The density of the resulting polyurethane polymer foam may be 10 kg/m³ or more, preferably 15 kg/m³ or more, more preferably 25 kg/m³ or more, most preferably 35 kg/m³ or more, and at the same time typically 200 kg/m³ or less, preferably 100 kg/m³ or less, more preferably 70 kg/m³ or less, and still most preferably 50 kg/m³ or less.

For the various embodiments, the polyurethane polymer foam of the present disclosure offers low smoke generation and high thermal stability determined according to ASTM E662 “Test Method for Specific Optical Density of Smoke Generated by Solid Materials”. Lower values of Maximum Specific Optical Density (Max Ds) mean lower smoke generation. Lower values of mass loss % mean greater thermal stability. The Max Ds may be 400 or less, preferably 200 or less, more preferably 100 or less, and still most preferably 50 or less. The mass loss % may be 50% or less, preferably 45% or less, more preferably 40% or less, and still most preferably 30% or less.

Polyurethane polymer foams of the present disclosure may have low thermal conductivity in applications such as for building insulation. Thermal conductivity of rigid foams is expressed by the K-factor. The K-factor is a measurement of the insulating properties. The K factor of the prepared foams may be 30.0 mW/mK or less, preferably 27.0 mW/mK or less, more preferably 24.0 mW/mK or less, and still most preferably 22.0 mW/mK or less. Thermal conductivity (K-Factor) was measured using ASTM C-518-17 at mean temperature of 75° F.

The applications for the polyurethane polymer foams produced by the present disclosure are those known in the industry. For example, the polyurethane polymer foams can be used for insulation used in building wall and roofing, in garage doors, in shipping trucks and railcars, and in cold storage facilities. The polyurethane polymer foams disclosed herein may have a combination of properties that are desirable for these applications. For instance, the polyurethane polymer foams disclosed herein may advantageously provide desirable low thermal conductivity, smoke density, thermal stability, and improved combustion characteristics with reduced HCN and CO emission.

The liquid transition metal chelating polyol blend and the polyurethane polymers of this disclosure can also be are useful, for example, as coatings, elastomers, sealants, binders, adhesives, or flexible foams. For use as a coating, elastomer, sealant, binder or adhesive, the reactants preferably are formulated into a two-component system (2K), one component containing the polyisocyanate (more preferably an isocyanate-terminated prepolymer or quasi-prepolymer) and the other component an isocyanate reactive composition containing at least one of the liquid transition metal chelating polyol blend imparting antifungal, antimicrobial, odor resistance, hardness, friction resistance, combustion/burning behavior modification, and/or the like to the cured polyurethane product. For use as a coating, elastomer, sealant, binder or adhesive, the liquid transition metal chelating polyol blend with other optional polyols may be pre-reacted with the organic polyisocyanate to form a prepolymer or quasi-prepolymer which contains isocyanate groups and utilized as one-component (1K) curing systems.

Some embodiments of the disclosure will now be described in detail in the following Examples.

### EXAMPLES

Some embodiments of the present disclosure will now be described in detail in the following Examples, wherein all parts and percentages are by weight unless otherwise specified. In the Examples, the following materials and tests are used.

Materials

Materials employed in the examples and/or comparative examples include the following.

Polyol A is a polyester polyol (an aromatic polyester polyol from terephthalic acid, Polyethylene Glycol 200, and diethylene glycol), having a hydroxyl number of 220 mg KOH/g and a functionality of 2 and a total content of aromatic moieties of 14.8 wt. %.

Polyol B is a polyester polyol (an aromatic polyester polyol from terephthalic acid, Polyethylene Glycol 200, glycerol, and diethylene glycol), having a hydroxyl number of 315 mg KOH/g and a functionality of 2.4 and a total content of aromatic moieties of 17.4 wt. %.

Polyethylene Glycol 200 (PEG 200) available from TCI America.

2,2′-Bipyridine (BIPY) available from Sigma-Aldrich.

2-[[2-(Dimethylamino)ethyl] methylamino]ethanol (TMDAOH) available from TCI America.

1-[Bis[3-(dimethylamino)propyl]amino-2-propanol] available from Sigma-Aldrich.

VORANOL™ RA 640 Polyol is an amine initiated polyol having a hydroxyl number of 654 mg KOH/g, viscosity of 21,500 cSt at 25° C. available from Dow Inc.

N,N,N′,N′-Tetramethylethylenediamine (TMEDA) available from ICI America.

Triethyl phosphate (TEP) is a fire retardant from LANXESS.

POLYCAT® 5 is a N,N,N′,N′,N″-Pentamethyldiethylenetriamine (PMDTA) catalyst from Evonik Industries AG.

POLYCAT® 46 is a catalyst from Evonik Industries AG.

Silicone Surfactant is a silicone rigid foam surfactant from Evonik Industries AG.

Water is deionized water having a specific resistance of 10 MS2×cm (million ohms) at 25° C.

Cyclopentane (c-Pentane) is a blowing agent from Sigma-Aldrich.

PAPI™ 580N is a polymethylene polyphenylisocyanate containing methylene diphenyl diisocyanate (MDI) with 30.8% isocyanate from Dow Inc.

Copper (II) hydroxide (Cu(OH)₂), technical grade, available from Sigma Aldrich.

Copper (I) oxide (Cu₂O), technical grade, available from Sigma Aldrich.

Copper (II) 2-ethylhexanoate (CuEH) available from Sigma Aldrich.

Copper (II) acetate monohydrate (Cu(OAc)₂H₂O) available from Acros Organics.

Copper (II) i-butyrate (Cu(I-But)₂ available from Strem Chemical.

Cobalt (H) acetate tetrahydrate (Co(OAc)₂ 4H₂O) available from Acros Organics.

Nickel (II) acetate tetrahydrate (Ni(OAc)₂ 4H₂O) available from Acros Organics.

Silver (I) acetate (Ag(OAc)) available from Fisher Scientific.

Preparation of Liquid Transition Metal Chelating Polyol Blends

Prepare each Liquid Transition metal Chelating Polyol Blend (LPB) in Table 1 by mixing a polyol, a transition metal compound, and a chelating agent in the amounts seen in Table 1 in a 250 mL plastic container at 3000 rpm with a FlackTek SpeedMixer™ DAC600 FVZ for 45 seconds. Next, place the container in a convection oven preheated to 80° C. for 1 hour (hr.). After 1 hr. mix the LPB again at 3000 rpm with the FlackTek SpeedMixer™ for 45 seconds.

To form a LPB containing transition metal, use an organic transition metal salt as the transition metal compound and a derivative of an amine-based chelating agent as the chelating agent, where the molar ratio of nitrogen (N) from the amine-based chelating agent to the transition metal (M) from the organic transition metal salt (N/M) is greater than 1.1, as seen in Table 1.

TABLE 1
Composition of Liquid transition metal chelating polyol blends (LPBs),
Inventive (EX) and Comparative (C EX) Compositions

| | | | | | Wt. % | Moles of | | |
|---|---|---|---|---|---|---|---|---|
| | | | | | Transition | N per 100 g | N/M | |
| | | | Transition metal | Chelating | metal in | of polyol | Molar | |
| | LPB | Polyol | Compound | Agent | mixture | in LPB | Ratio | Form of LPB |
| C EX1 | LPB 1 | POLYOL A | Cu₂O | BIPY | 1.42% | 0.048 | 2.0 | liquid/solid mixture |
| C EX2 | LPB 2 | POLYOL A | Cu(OH)₂ | BIPY | 2.67% | 0.094 | 2.0 | liquid/solid mixture |
| C EX3 | LPB 3 | POLYOL A | Cu₂O | TMEDA | 2.75% | 0.094 | 2.0 | liquid/solid mixture |
| C EX4 | LPB 4 | POLYOL A | Cu(OH)₂ | TMEDA | 2.72% | 0.094 | 2.0 | liquid/solid mixture |
| C EX5 | LPB 5 | POLYOL A | Cu(OAc)₂ H₂O | TMEDA | 1.41% | 0.024 | 1.0 | liquid/solid mixture |
| C EX6 | LPB 6 | POLYOL A | Cu(OAc)₂ H₂O | PMDTA | 2.67% | 0.032 | 1.0 | liquid/solid mixture |
| EX 1 | LPB 7 | POLYOL A | CuEH | BIPY | 2.42% | 0.094 | 2.0 | liquid |
| EX 2 | LPB 8 | POLYOL A | Cu(OAc)₂ H₂O | BIPY | 1.38% | 0.048 | 2.0 | liquid |
| EX 3 | LPB 9 | POLYOL A | Cu(I-But)₂ | BIPY | 2.53% | 0.094 | 2.0 | liquid |
| EX 4 | LPB 10 | POLYOL A | Cu(OAc)₂ H₂O | TMEDA | 2.61% | 0.094 | 2.0 | liquid |
| EX 5 | LPB 11 | POLYOL A | Cu(OAc)₂ H₂O | TMEDA | 2.64% | 0.070 | 1.5 | liquid |
| EX 6 | LPB 12 | POLYOL A | Cu(OAc)₂ H₂O | PMDTA | 1.41% | 0.027 | 1.1 | liquid |
| EX 7 | LPB 13 | POLYOL A | Cu(OAc)₂ H₂O | PMDTA | 2.64% | 0.072 | 1.5 | liquid |
| EX 8 | LPB 14 | POLYOL A | Cu(OAc)₂ H₂O | TMEDA/ | 1.40% | 0.036 | 1.5 | liquid |
| | | | | PMDTA (¾ | | | | |
| | | | | molar ratio) | | | | |
| EX 9 | LPB 15 | POLYOL A | Cu(OAc)₂ H₂O | TMEDA | 0.73% | 0.100 | 8.0 | liquid |
| EX 10 | LPB 16 | POLYOL A | Cu(OAc)₂ H₂O | TMEDA | 7.77% | 0.400 | 2.0 | liquid |
| EX 11 | LPB 17 | PEG200 | Cu(OAc)₂ H₂O | RA640 | 0.94% | 0.070 | 4.1 | liquid |
| EX 12 | LPB 18 | POLYOL A | Co(OAC)₂4H₂O | TMEDA | 1.55% | 0.058 | 2.0 | liquid |
| EX 13 | LPB 19 | POLYOL A | Ni(OAC)₂ 4H₂O | TMEDA | 2.45% | 0.136 | 2.7 | liquid |
| EX 14 | LPB 20 | POLYOL A | Cu(OAc)₂ H₂O | TMDAOH | 1.34% | 0.045 | 2.0 | liquid |

Preparation of Polyurethane Foam Using Liquid Transition Metal Chelating Polyol Blends

Use the following components in the reaction mixtures (Table 2) to form polyurethane foams for Inventive Examples (EX) and Comparative Examples (C Ex). The amounts of each component are given in parts by weight (PBW) based on the total weight of the reaction mixture used to form the polyurethane foam.

TABLE 2
Reaction Mixture for Polyurethane Foams using LPB

| Component | C Ex A(ctrl) | EX 1 | EX 2 | EX 3 | EX 4 | EX 5 | EX 6 | EX 7 |
|---|---|---|---|---|---|---|---|---|
| Formulated | | | | | | | | |
| Isocyanate- | | | | | | | | |
| Reactive | | | | | | | | |
| Composition | | | | | | | | |
| POLYOL A | 16.34 | | 7.87 | 7.77 | 2.39 | | | 9.66 |
| POLYOL B | 5.44 | 5.39 | 5.39 | 5.39 | 5.36 | 5.42 | 5.41 | 5.43 |
| LPB 8 | 17.47 | | | | | | | |
| LPB 10 | | | 9.49 | | | | | |
| LPB 11 | | | | 9.50 | 15.45 | | | |
| LPB 12 | | | | | | 17.16 | | |
| LPB 14 | | | | | | | 17.29 | 7.07 |
| TEP | 3.84 | 3.80 | 3.81 | 3.81 | 3.79 | 3.82 | 3.81 | 3.83 |
| POLYCATO ® 5 | 0.26 | 0.05 | 0.10 | 0.01 | 0.01 | 0.15 | | |
| catalyst | | | | | | | | |
| POLYCATO ® 46 | 0.49 | 0.48 | 0.48 | 0.48 | 0.48 | 0.48 | 0.48 | 0.49 |
| catalyst | | | | | | | | |
| Silicon Surfactant | 0.77 | 0.76 | 0.76 | 0.76 | 0.76 | 0.76 | 0.76 | 0.77 |
| Water | 0.20 | 0.20 | 0.20 | 0.20 | 0.20 | 0.20 | 0.20 | 0.20 |
| Cyclopentane | 5.38 | 5.33 | 5.33 | 5.33 | 5.30 | 5.34 | 5.34 | 5.36 |
| Isocyanate | | | | | | | | |
| PAPI ™ 580N | 67.28 | 66.57 | 66.62 | 66.66 | 66.27 | 66.81 | 66.70 | 67.04 |
| Formulation | | | | | | | | |
| Characteristics | | | | | | | | |
| Transition metal | 0 | 0.25 | 0.25 | 0.25 | 0.41 | 0.25 | 0.24 | 0.10 |
| wt. %* | | | | | | | | |
| Cream time, | 7 | 5 | 7 | 7 | 7 | 6 | 7 | 6 |
| seconds (s) | | | | | | | | |
| Gel time, s | 29 | 19 | 28 | 28 | 29 | 26 | 29 | 26 |
| Tack free time, s | 68 | 50 | 65 | 68 | 69 | 58 | 67 | 61 |
| Relative HCN | 1.00 | 0.83 | 0.47 | 0.47 | 0.42 | 0.75 | 0.69 | 0.81 |
| content | | | | | | | | |
| Relative | 1.00 | 0.83 | 0.62 | 0.75 | 0.58 | 0.75 | 0.80 | 0.94 |
| isocyanurate | | | | | | | | |
| content | | | | | | | | |

Wt. %* - weight percent based on total weight of reaction mixture.

Prepare the polyurethane foams as follows. Prepare a reaction mixture having a total weight of 80 grams (g) for each EX and C EX provided in Table 2 in a 500 mL beaker. Mix the components of the isocyanate-reactive composition provided in Table 2 at 3000 rpm with a rotary mixer for 10 seconds (s). Next, mix the isocyanate-reactive composition and isocyanate in the beaker again at 3000 rpm for 5 s at room conditions (23° C., 50% relative humidity). After 24 hours (h), remove the foam section that has risen above the plane of the beaker top and then excise a center core of 2.54 cm×2.54 cm×2.54 cm. The cream time is defined as the time from the preparation of the reaction mixture until the recognizable beginning of the foaming mixture such as a visual change of the reactants (color change and/or start of rise) occurs. The gel time (or string time) is defined as the time from the preparation of the reaction mixture until the transition from the fluid to the solid state is reached. It is determined by repeatedly dipping and pulling out a wood tongue depressor into the reaction mixture. The gel time is reached as soon as strings are formed while pulling the wood tongue depressor out of the reaction mixture. The tack-free time is defined as the time from the preparation of the foam reaction mixture until the surface of the foam is tack free. It is determined by depositing a wood tongue depressor on the foam surface. The tack-free time is reached if lifting the wood tongue depressor does not lead to delamination or rupture of the foam surface, in other words, when the foam surface is not tacky anymore.

Analysis of Composition of Smoke Gases

Conduct pyrolysis testing using a Frontier Labs 2020D pyrolyzer mounted on an Agilent 6890 GC with a flame ionization detector (FID). Weigh approximate 200-250 μg of sample into a Frontier labs silica lined stainless steel cup. Perform the pyrolysis by a single shot mode by dropping the sample cup into the oven for analysis under air conditions at 600° C. for 2 min followed under helium conditions for another 2 min. Trap the volatile products emitted from the sample at the head of the separation column using a micro-cryo trapping device (MCT). Achieve separation using a 10 m×0.32 mm ID×5 μm PoraBond Q column from Agilent with a HP-1 (10 m×0.53 mm×2.65 μm) as a guard column. Use the back-inlet pressure for the backflush purpose (a 0.5 m×0.53 mm guard column using back-inlet as its head pressure tee into PoraBond Q and HP-1 columns). The HCN was detected on back FID detector. Use a normalized peak area of HCN by sample weight for HCN concentration comparison.

GC Conditions: Front injection Port: 300° C.; Split injector at 1:1; Ramped pressure: 4.9 psi hold for 1.5 min, then to 3.1 psi at 50 psi/min; Back injection port: 4 psi; GC Oven: 40° C. hold for 3 min, to 240° C. at 30° C./min; FID: 250° C., H₂ flow: 40 mL/min, air flow: 450 mL/min, make-up gas (N₂): 30 mL/min, 50 Hz.

Relative Isocyanurate Content Measurement

Conduct Attenuated Total Reflectance Fourier Transform Infrared Spectroscopy (ATR-FTIR) test on a Nicolet iS50 FT-IR instrument with SMART iTX single bounce diamond ATR. Acquire sixteen scans in the 4000-600 cm⁻¹ spectral range with a resolution of 4 cm⁻¹. Cut a rectangular cross section (10 mm×60 mm) from the center of a molded polyurethane-based foam sample. Conduct three tests on the cross section averaging the 3 measurements for the characteristic peak. The relative isocyanurate content is defined as the ratio of isocyanurate group characteristic peak height (˜1409 cm⁻¹) and phenyl group characteristic peak height (˜1595 cm⁻¹) normalized by this peak height ratio for Comparative Control Example with no transition metal.

Results

As seen in Table 2, a significant reduction of HCN generation is achieved with foams containing liquid transition metal chelating polyol blends containing copper. The examples show similar reactivity as C EX A.

1. A liquid transition metal chelating polyol blend, comprising:
a polyol;
0.05 weight percent (wt. %) to 10.0 wt. % of a transition metal ion from a transition metal compound, the wt. % based on the total weight of the liquid transition metal chelating polyol blend; and
a chelating agent having a nitrogen based chelating moiety, wherein the liquid transition metal chelating polyol blend has 0.001 to 1.0 moles of nitrogen in the nitrogen based chelating moieties per 100 gram (g) of the polyol in the liquid transition metal chelating polyol blend, and has a molar ratio of nitrogen in the nitrogen based chelating moiety to the transition metal ion of 8.0:1.0 to 1.0:1.0.

2. The liquid transition metal chelating polyol blend of claim 1, wherein the polyol is an aromatic polyester polyol having an aromatic moiety that constitutes 5 weight percent (wt. %) to 60 wt. % of the total weight of the aromatic polyester polyol.

3. The liquid transition metal chelating polyol blend of claim 1, wherein the transition metal compound is selected from the group consisting of a transition metal carboxylate, a transition metal salt, a transition metal coordinate compound, and combinations thereof and the transition metal ion is selected from the group consisting of a transition metal ion of copper, zinc, silver, iron, manganese, cobalt, nickel, zirconium and combinations thereof; or
wherein the transition metal compound is selected from the group consisting of copper (11) 2-ethylhexanoate (CuEH), copper (II) acetate, copper (II) acetate monohydrate (Cu(OAc)₂ H₂O), copper(II) propionate, copper (II) isobutyrate (Cu(i-Bu)₂), cobalt (II) acetate, nickel (II) acetate, silver (I) acetate and combinations thereof.

4. The liquid transition metal chelating polyol blend of claim 1, wherein the nitrogen based chelating moiety is selected from the group consisting of a diamine chelating moiety, a triamine chelating moiety, a tetraamine chelating moiety and combinations thereof.

5. The liquid transition metal chelating polyol blend of claim 1, wherein the chelating agent having a nitrogen based chelating moiety is selected from the group consisting of 2,2′-bipyridine, N,N,N′,N′-tetramethylethylenediamine, N,N,N′,N′,N″-pentamethyldiethylenetriamine, 2-[[2-(dimethylamino)ethyl] methylamino]ethanol, 1-[bis[3-(dimethylamino)propyl]amino-2-propanol], a 1,2-ethanediamine polymer with methyl oxirane and combinations thereof.

6. An isocyanate-reactive composition, comprising:
the liquid transition metal chelating polyol blend of claim 1; and
a polyol separate from the polyol of the liquid transition metal chelating polyol blend, wherein the isocyanate-reactive composition includes 0.1 to 100 weight percent (wt. %) of the liquid transition metal chelating polyol blend and up to 99.9% wt. % of the polyol separate from the polyol of the liquid transition metal chelating polyol blend to form the isocyanate-reactive composition, the wt. % based on the total weight of the isocyanate-reactive composition.

7. The isocyanate-reactive composition of claim 6, further including 0.1 wt. % to 7.0 wt. % of phosphorus from a flame-retardant compound selected from the group consisting of a phosphate, a phosphonate, a phosphinate, a phosphite and combinations thereof, the wt. % based on the total weight of the isocyanate-reactive composition; or
further including a catalyst, a blowing agent and a surfactant for use in forming a polyurethane polymer foam; or
optionally further including water for use in forming the polyurethane polymer foam.

8. A reaction mixture for forming a polyurethane polymer or a reaction mixture for forming a polyurethane foam, comprising:
an isocyanate compound having an isocyanate moiety; and
the isocyanate-reactive composition of claim 6, wherein the polyol includes a hydroxyl moiety, and the reaction mixture has a molar ratio of the isocyanate moiety to the hydroxyl moiety of 0.90:1 to 7:1.

9. A process for preparing a liquid transition metal chelating polyol blend, the process comprising:
providing a polyol;
providing a chelating agent having a nitrogen based chelating moiety;
providing a transition metal compound having a transition metal ion;
admixing the polyol, the chelating agent and the transition metal compound to form the liquid transition metal chelating polyol blend having 0.001 to 1.0 moles of nitrogen in the nitrogen based chelating moieties per 100 g of the polyol in the liquid transition metal chelating polyol blend and having a molar ratio of nitrogen in the nitrogen based chelating moiety to the transition metal ion of 8.0:1.0 to 1.0:1.0.

10. A process for preparing a reaction mixture for producing a polyurethane polymer, the process comprising:
providing an isocyanate-reactive composition of claim 6;
providing an isocyanate compound having an isocyanate moiety; and
admixing the isocyanate-reactive composition and the isocyanate compound to form the reaction mixture having a molar ratio of the isocyanate moiety to the hydroxyl moiety of 0.90:1 to 7:1.
